(19) United States
(12) Patent Application Publication
(10) Pub. No.: US 2015/0217692 A1
(43) Pub. Date: Aug. 6, 2015

(54) IMAGE GENERATION APPARATUS AND IMAGE GENERATION PROGRAM PRODUCT

(71) Applicant: DENSO CORPORATION, Kariya-city, Aichi (JP)

(72) Inventor: Hirohiko Yanagawa, Chiryu-city (JP)

(73) Assignee: DENSO CORPORATION, Kariya-city (JP)

(21) Appl. No.: 14/426,471

(22) PCT Filed: Oct. 8, 2013
(86) PCT No.: PCT/JP2013/005993

§ 371 Date: Mar. 6, 2015

(30) Foreign Application Priority Data
Oct. 29, 2012 (JP) 2012-237922

(51) Int. Cl. B60R 1/00; H04N 7/18; H04N 5/77

(52) U.S. Cl. CPC B60R 1/00; H04N 5/77; H04N 7/181; B60R 2300/105; B60R 2300/303; B60R 2300/70; B60R 2300/8086; B60R 2300/8093

(57) ABSTRACT

In an image display system, an image processing portion uses a function of a display image synthesis section to generate a display image to be displayed on a display portion from at least a part of a plurality of images. Further, the image processing portion uses a function of a record image synthesis section to generate a record image to be recorded from at least a part of the plurality of images. The record image is different from the display image. This enables to use the display image to provide parking assistance and record the record image with a drive recorder. The image display system can be used to not only provide parking assistance but also exercise a function of the drive recorder.

### CROSS REFERENCE TO RELATED APPLICATIONS

The present disclosure is a U.S. national stage application of International Patent Application No. PCT/JP2013/005993 filed on Oct. 8, 2013 and is based on Japanese Patent Application No. 2012-237922 filed on Oct. 29, 2012, the disclosures of which are incorporated herein by reference.

### TECHNICAL FIELD

The present disclosure relates to an image generation apparatus and an image generation program product that are used to generate an image based on information acquired from a plurality of image pickup portions.

### BACKGROUND

A well-known image generation apparatus disclosed, for instance, in Patent Literature 1 generates a top-view image from a plurality of images to present an overhead shot of a host vehicle and uses the generated top-view image in order to provide parking assistance.

### PATENT LITERATURE

Patent Literature 1: JP H03-099952 A

### SUMMARY

In contrast, a high demand in recent years requires a drive recorder for recording an image in the event of an accident (accident image). This may lead to recording a top-view image for parking assistance as an accident image. However, the top-view image does not usually show the conditions of a surrounding area such as a color of a traffic light. Thus, the top-view image is not suitable for depicting an accident.

It is an object of the present disclosure to provide an image generation apparatus and an image generation program product that are used to generate an image based on information acquired from a plurality of image pickup portions and capable of providing parking assistance and functioning as a drive recorder.

To achieve the above object, according to an example of the present disclosure, an image generation apparatus is provided to include a display image generation section and a record image generation section. The display image generation section generates a display image to be displayed on a display portion from at least a part of a plurality of images. The record image generation section generates a record image to be recorded from at least a part of the plurality of images. The record image is different from the display image.

The above-described image generation apparatus separately generates the display image and the record image. This makes it possible to provide parking assistance by using the display image, which is suitable for display, and to exercise a function of a drive recorder in order to record the record image, which is suitable for recording. Consequently, the image generation apparatus can be used to not only provide parking assistance but also exercise the function of a drive recorder.

Even if the display image and the recording image are temporarily identical with each other, the above-described image generation apparatus does not malfunction as far as the display image and the record image differ from each other at any point of time. Further, at least either one of the display image and the record image may be generated by combining images derived from a plurality of image pickup portions.

In order to achieve the above-mentioned object, according to another aspect of the present disclosure, there is provided an image generation program product that includes instructions for causing a computer to function as individual sections forming the image generation apparatus and is stored on a computer-readable non-transitory storage medium. Definitions contained in appended claims may be arbitrarily combined wherever possible. In such an instance, some elements may be excluded as far as the object of the present disclosure is achievable.

### BRIEF DESCRIPTION OF DRAWINGS

The above and other objects, features and advantages of the present disclosure will become more apparent from the following detailed description made with reference to the accompanying drawings. In the drawings:

FIG. 1 is a schematic block diagram illustrating a configuration of an image display system to which the present disclosure is applied;

FIG. 2 is a flowchart illustrating an image generation process performed by a CPU in an image processing portion;

FIG. 3 is a flowchart illustrating an image selection process included in the image generation process; and

FIG. 4 is an explanatory diagram illustrating exemplary combinations of a display image and a record image.

### DETAILED DESCRIPTION

Embodiments of the present disclosure will now be described with reference to the accompanying drawings.

### [Configuration of Embodiment]

An image display system 1 to which the present disclosure is applied is mounted in a vehicle such as a passenger vehicle. A vehicle in which the image display system 1 is mounted is referred to as a host vehicle or as a subject vehicle.

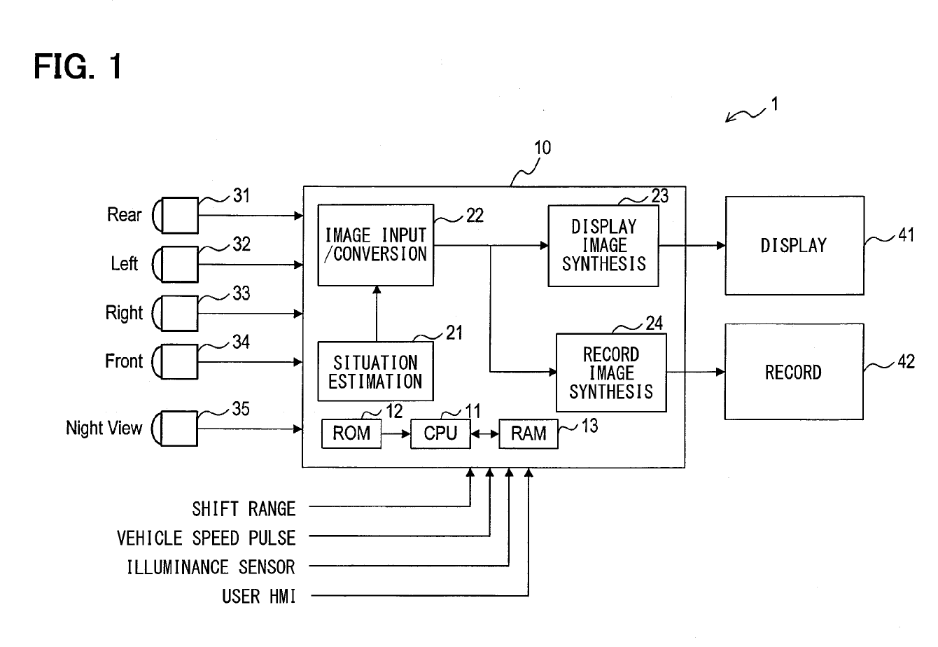

The image display system 1 is capable of generating a display image and a record image from a plurality of captured images. The display image is used for display purposes, whereas the record image is used for recording purposes. More specifically, as shown in FIG. 1, the image display system 1 includes a plurality of cameras 31-35, an image processing portion 10, a display portion 41, and a recording portion 42.

The cameras 31-35 include a rear camera 31, a left camera 32, a right camera 33, a front camera 34, and a night view camera 35. The rear camera 31 captures a rear view from the host vehicle. The left camera 32 captures a left side view from the host vehicle. The right camera 33 captures a right side view from the host vehicle. The front camera 34 and the night view camera 35 each capture a front view from the host vehicle. A range captured by the night view camera 35 is substantially the same as that is captured by the front camera 34. However, the night view camera 35 differs from the front camera 34 in that the former is capable of functioning as a night vision camera.

Ranges captured by the rear camera 31, the left camera 32, the right camera 33, and the front camera 34 partly overlap. Combining individual images captured by those cameras enables to obtain an image showing the entire periphery of the host vehicle.

The display portion 41 is a well-known display. The display portion 41 displays a display image that is generated by the image processing portion 10.

The recording portion 42 is a well-known recorder capable of recording images. The recording portion 42 records a record image that is generated by the image processing portion 10. The recording portion 42 is capable of recording an image for a predetermined period of time (for example, approximately one hour). After an image has been recorded for the predetermined period of time, newly recorded image data sequentially overwrites the oldest one.

The image processing portion 10 is a well-known computer including a CPU 11, a ROM 12, and a RAM 13. The CPU 11 in the image processing portion 10 performs various processes, such as a later-described image generation process, based on a program (such as an image generation program) recorded, for instance, in the ROM 12.

The image processing portion 10 is capable of functioning as a situation estimation section 21, an image input/conversion section 22, a display image synthesis section 23, and a record image synthesis section 24. Processes of these sections are performed by the CPU 11. The situation estimation section 21 receives information from various sensors mounted in the host vehicle, such as information about a gear shift range (gear shift position), information about vehicle speed, information about vehicle periphery brightness detected by an illuminance sensor, and information about user manipulations, estimates the running condition and running environment of the host vehicle, and selects the type of image to be generated.

In the present application, the word “information” is used not only as an uncountable noun but also as a countable noun.

The image input/conversion section 22 inputs an image required for generating the selected type of image (display image or record image), and generates an image to be processed, such as a rear panoramic image or a top-view image representing an overhead shot of the host vehicle. The top-view image is derived from a combination of images captured by the plurality of cameras 31-34 that are used to capture images showing the entire periphery of the host vehicle. A well-known technology is used to acquire the top-view image. The rear panoramic image is derived from a combination of images captured by the rear camera 31, the left camera 32, and the right camera 33, which are used to capture images from both sides and rear of the host vehicle. A process for acquiring the rear panoramic image is also provided by a well-known technology.

The display image synthesis section 23 and the record image synthesis section 24 select one or more images from a plurality of images acquired or generated by the image input/conversion section 22 and generate an image to display or record. Subsequently, the display image synthesis section 23 outputs the generated image to the display portion 41; the record image synthesis section 24 outputs the generated image to the recording portion 42.

### [Process of Embodiment]

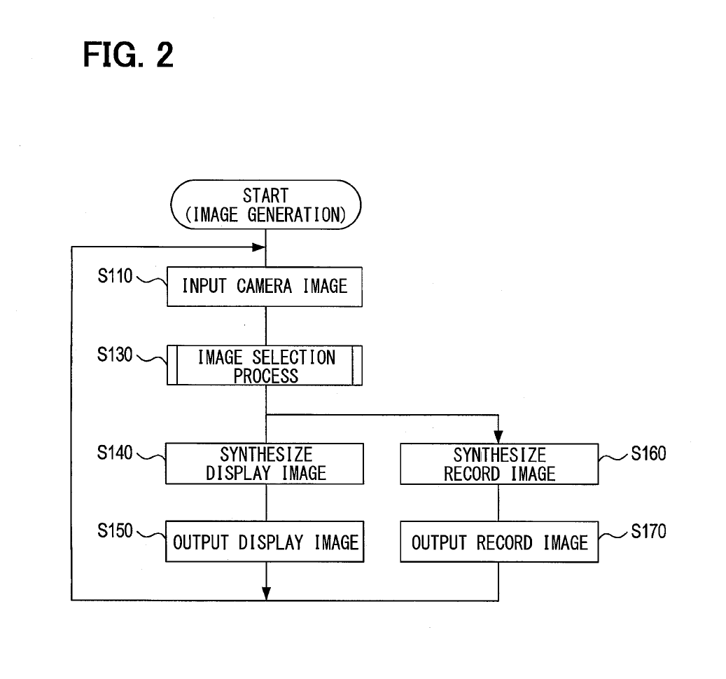

In the above-described image display system 1, the image processing portion 10 (CPU 11) performs an image generation process shown in FIG. 2. The image generation process starts when, for instance, the host vehicle is turned on.

It is noted that a flowchart or the processing of the flowchart in the present application includes sections (also referred to as steps), each of which is represented, for instance, as S110. Further, each section can be divided into several sub-sections while several sections can be combined into a single section. Furthermore, each of thus configured sections can be also referred to as a device, module, or means. Each or any combination of sections explained in the above can be achieved as (i) a software section in combination with a hardware unit (e.g., computer) or (ii) a hardware section, including or not including a function of a related apparatus; furthermore, the hardware section (e.g., integrated circuit, hard-wired logic circuit) may be constructed inside of a microcomputer.

In the image generation process, as shown in FIG. 2, images captured by the cameras 31-35 are first acquired (S110). Next, the situation estimation section 21 performs an image selection process (S130). The image selection process is performed to select the type of image to be generated based on the running condition or running environment of the host vehicle.

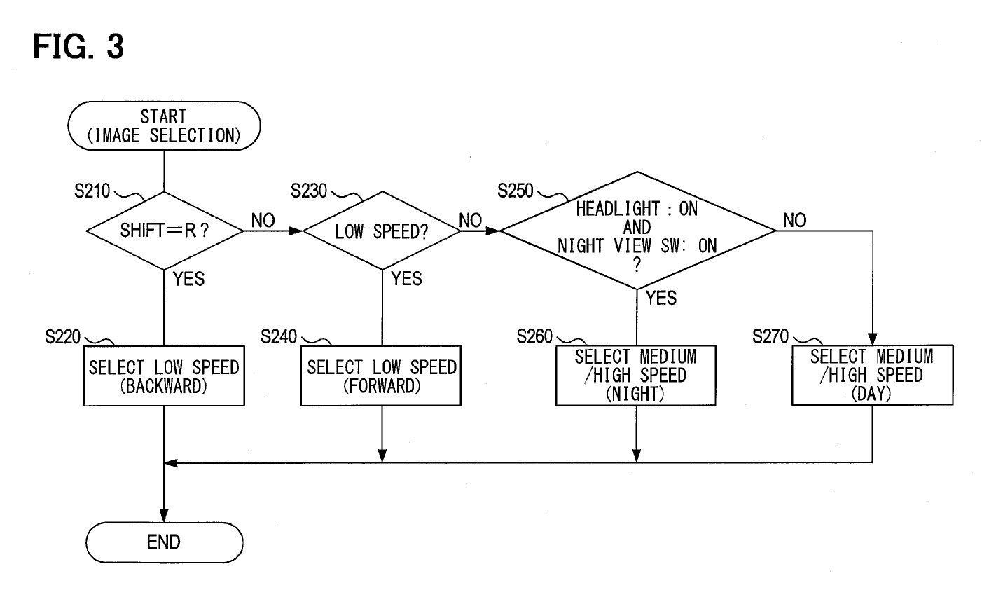

More specifically, as shown in FIG. 3, it is first determined whether the selected gear shift position is R (reverse) (S210). If the selected gear shift position is R (S210: YES), a low-speed running (or low-speed manipulation) (backward movement) mode is selected (S220) to terminate the image selection process.

If the selected gear shift position is not R (S210: NO), it is determined whether the speed of the host vehicle is low (S230). The speed of the host vehicle is considered to be low when the host vehicle is running at a reduced speed for traveling on a very narrow path or for parking, or more specifically, running at a speed lower than, for instance, 30 km/h.

If the speed of the host vehicle is low (S230: YES), a low-speed running (or low-speed manipulation) (forward movement) mode is selected (S240) to terminate the image selection process. If the speed of the host vehicle is not low (S230: NO), it is determined whether a night view switch is turned on to use headlights and the night view camera 35 (S250).

If the headlights and the night view camera 35 are turned on (S250: YES), a medium-/high-speed running (nighttime) mode is selected (S260) to terminate the image selection process. If the headlights and the night view camera 35 are turned off (S250: NO), a medium-/high-speed running (daytime) mode is selected (S270) to terminate the image selection process.

When the above-described image selection process terminates, processing returns to FIG. 2 so that the image input/conversion section 22 and the display image synthesis section 23 combine images to obtain a display image (S140) and output the display image to the display portion 41 (S150). Further, the image input/conversion section 22 and the record image synthesis section 24 combine images to obtain a record image (S160) and output the record image to the recording portion 42 (S170).

The types of images generated by processes performed in S140 and S160 will now be described in detail.

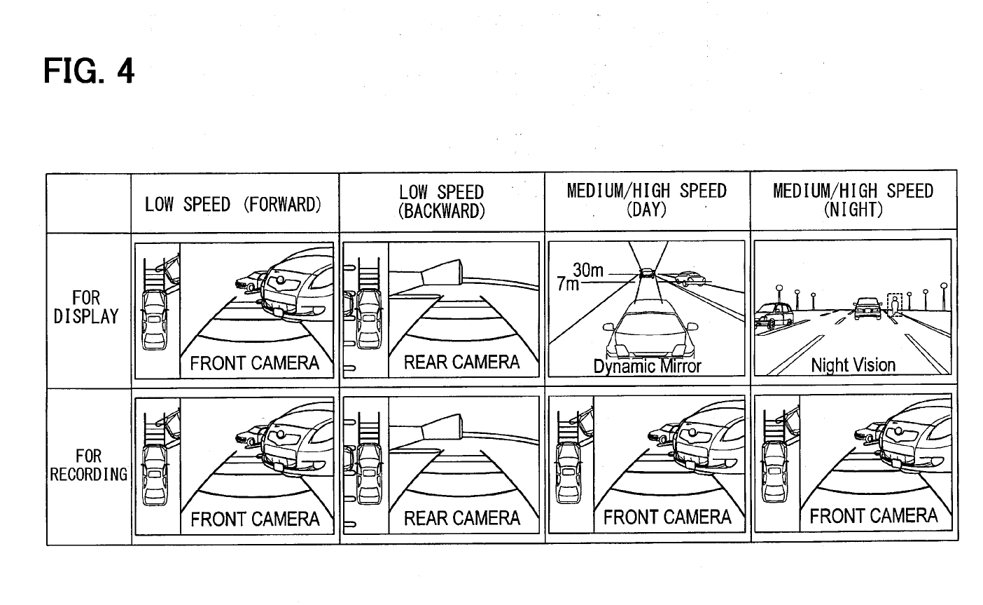

If the low-speed running (forward movement) mode is selected in the image selection process, the display image synthesis section 23 and the record image synthesis section 24 generate an image in which a top-view image and an image captured by the front camera 34 are arranged side by side as shown in FIG. 4. If the low-speed running (backward movement) mode is selected in the image selection process, the display image synthesis section 23 and the record image synthesis section 24 generate an image in which a top-view image and an image captured by the rear camera 31 are arranged side by side. When a vehicle is running at a low speed, it is desirable that a driver of the vehicle move the vehicle while watching the area in the direction of running and confirming the periphery of the vehicle. Thus, the top-view image and an image for watching the area in the direction of running are generated as described above for the purpose of assisting the driver and recording.

The present embodiment has been described on the assumption that the display image synthesis section 23 and the record image synthesis section 24 generate similar images when the low-speed running (forward movement) mode or the low-speed running (backward movement) mode is selected. Alternatively, the record image synthesis section 24, for example, may generate a record image different from a display image, or more specifically, a record image in which a larger area is occupied by the top-view image than in the display image. In such an alternative case, processing load is reduced by using a record image derived from an image identical with an image that is prepared by the image input/conversion section 22 for a display image.

If the medium-/high-speed running (daytime) mode is selected in the image selection process, the display image synthesis section 23 generates a rear panoramic image, whereas the record image synthesis section 24 generates an image in which a top-view image and an image captured by the front camera 34 are arranged side by side. The top-view image and the image captured by the front camera 34 have a wider angle of view (image display range) than the rear panoramic image.

If the speed of the host vehicle is relatively high, a rear-view image, which is difficult to view during a high-speed travel, is generated as a display image to provide driving assistance. Further, an image showing objects in the direction of running is employed as a record image.

If the medium-/high-speed running (nighttime) mode is selected in the image selection process, the display image synthesis section 23 generates a raw image that is acquired directly from the night view camera 35, whereas the record image synthesis section 24 generates an image in which a top-view image and an image captured by the front camera 34 are arranged side by side. In this instance, the record image may be obtained by combining a top-view image with an image captured by the night view camera 35.

### [Advantageous Effects of Embodiment]

In the image display system 1 described in detail above, the image processing portion 10 uses the function of the display image synthesis section 23 to generate a display image to be displayed on the display portion 41 from at least a part of a plurality of images. Further, the image processing portion 10 uses the function of the record image synthesis section 24 to generate a record image to be recorded from at least a part of a plurality of images. The record image is different from the display image.

The above-described image display system 1 separately generates a display image and a record image. Thus, the display image is used for the purpose of providing parking assistance, while the record image is recorded as a function of a drive recorder. Consequently, the image display system 1 can be used to not only provide parking assistance but also exercise the function of a drive recorder.

Further, in the above-described image display system 1, the image processing portion 10 generates a record image that shows a larger imaging range than a display image.

The above-described image processing portion 10 enables to record an image having a larger imaging range as a captured image. This enables to record the periphery of the host vehicle so as to capture an area in the direction of an object that may approach and be about to collide with the host vehicle.

Furthermore, in the above-described image display system 1, the image processing portion 10 generates a record image by using images including raw images (captured images no part of which is deleted) that are directly inputted from the cameras 31-35.

The above-described image processing portion 10 generates a record image by using images including raw images showing the whole region included in images captured by the cameras 31-35. This enables to generate an image that shows an enlarged range.

Moreover, in the above-described image display system 1, the image processing portion 10 generates a record image that includes an image showing objects in the direction of running of the host vehicle.

The above-described image processing portion 10 can generate a record image that properly shows objects in the direction of running of the host vehicle.

Besides, in the above-described image display system 1, the image processing portion 10 changes the type of image to be generated based on the running condition or running environment of the host vehicle.

The above-described image processing portion 10 can generate an optimal image based on the running condition or running environment of the host vehicle.

In addition, in the above-described image display system 1, the image processing portion 10 generates a record image including a plurality of images, and uses one or more of the plurality of images as at least a part of a display image.

The above-described image processing portion 10 directly uses a part of the display image for the record image as well. This enables to reduce the processing load on the generation of the record image.

Additionally, in the above-described image display system 1, the image processing portion 10 generates a record image including a top-view image.

The above-described image processing portion 10 can generate and record a top-view image when the host vehicle approaches an object. This facilitates the recognition of the direction in which the object is approaching the host vehicle, from the recorded image.

### [Alternative Embodiments]

The present disclosure is not limited to the above-described embodiment and may be implemented in various alternative embodiments as far as they fall within the technical scope of the present disclosure.

For example, although the process in S140 to S150 and the process in S160 to S170 are performed in parallel in the above-described embodiment, those processes may be performed in series. Further, when the medium-/high-speed running (nighttime) mode is selected, the image to be used for recording may be changed based on the brightness of the periphery and the recognition performance of a normal camera (front camera 34).

The image processing portion 10 according to the embodiment is also referred to as an image generation apparatus. The cameras 31-35 according to the embodiment are also referred to as image pickup portions. Further, the display image synthesis section 23 according to the embodiment may be referred to as a display image generation section, device, or means. The record image synthesis section 24 according to the embodiment may be referred to as a record image generation section, device, or means.

While the present disclosure has been described with reference to the foregoing embodiments, it is to be understood that the disclosure is not limited to the foregoing embodiments and their structures. The present disclosure is intended to cover various modifications and equivalent arrangements. In addition, while the various combinations and configurations, and other combinations and configurations, including only one element or more or fewer elements, are also within the spirit and scope of the present disclosure.

1. An image generation apparatus that is mounted in a vehicle to generate a plurality of images based on information acquired from a plurality of image pickup portions, the image generation apparatus comprising:
a display image generation section that generates a display image to be displayed on a display portion from at least a part of the plurality of images; and
a record image generation section that generates a record image to be recorded from at least a part of the plurality of images, the record image being different from the display image,
wherein the record image generation section generates a record image showing a larger imaging range than the display image.

2. (canceled)

3. The image generation apparatus according to claim 1, wherein
the record image generation section generates an image including a raw image captured by and directly inputted from a subject image pickup portion as the record image.

4. The image generation apparatus according to claim 1, wherein
the record image generation section generates a record image including an image showing objects in a running direction of a host vehicle.

5. The image generation apparatus according to claim 1, wherein
the display image generation section changes a type of image to be generated based on a running condition or a running environment of a host vehicle.

6. The image generation apparatus according to claim 1, wherein
the record image generation section generates a record image including several images that includes at least a part of the display image.

7. The image generation apparatus according to claim 1, wherein
the record image generation section generates a record image including a top-view image representing an overhead shot of a host vehicle.

8. An image generation program product that includes instructions for causing a computer to function as the sections comprised by the image generation apparatus according to claim 1, and is stored on a computer-readable non-transitory storage medium.

9. An image generation apparatus that is mounted in a vehicle to generate a plurality of images based on information acquired from a plurality of image pickup portions, the image generation apparatus comprising:
a display image generation section that generates a display image to be displayed on a display portion from at least a part of the plurality of images; and
a record image generation section that generates a record image to be recorded from at least a part of the plurality of images, the record image being different from the display image,
wherein the record image generation section generates a record image including an image showing objects in a running direction of a host vehicle.

10. The image generation apparatus according to claim 9, wherein
the record image generation section generates a record image showing a larger imaging range than the display image.

11. The image generation apparatus according to claim 10, wherein
the record image generation section generates an image including a raw image captured by and directly inputted from a subject image pickup portion as the record image.

12. The image generation apparatus according to claim 9, wherein
the display image generation section changes a type of image to be generated based on a running condition or a running environment of a host vehicle.

13. The image generation apparatus according to claim 9, wherein
the record image generation section generates a record image including several images that includes at least a part of the display image.

14. The image generation apparatus according to claim 9, wherein
the record image generation section generates a record image including a top-view image representing an overhead shot of a host vehicle.

15. An image generation program product that includes instructions for causing a computer to function as the sections comprised by the image generation apparatus according to claim 9 and is stored on a computer-readable non-transitory storage medium.
